(19) United States
(12) Patent Application Publication
(10) Pub. No.: US 2012/0201661 A1
(43) Pub. Date: Aug. 9, 2012

(54) CONTAMINANT SHIELD SYSTEM FOR A SHAFT

(75) Inventors: Vishwas Kumar Pandey, Bangalore (IN); Rohit Pruthi, Bangalore (IN); Stephen Roger Swan, Ballston Lake, NY (US)

(73) Assignee: GENERAL ELECTRIC COMPANY, Schenectady, NY (US)

(21) Appl. No.: 13/022,116

(22) Filed: Feb. 7, 2011

(51) Int. Cl. F01D 11/00; F16J 15/40

(52) U.S. Cl. 415/175; 277/431

(57) ABSTRACT

Systems for shielding a shaft from contaminants are disclosed. In one embodiment, a contaminant shield system for a shaft includes: a fluid seal disposed circumferentially about the shaft, the fluid seal substantially fluidly isolating an inner portion of the shaft from atmospheric air; an oil deflector ring disposed circumferentially about the inner portion of the shaft, the oil deflector ring having an inner surface facing a portion of the shaft exposed to a lubricating oil and an outer surface facing the fluid seal; and a fluid conduit interposed between the fluid seal and the outer surface of the oil deflector ring, the fluid conduit for receiving a fluid and releasing the fluid between the fluid seal and the outer surface of the oil deflector ring creating a positive pressure differential.

### BACKGROUND OF THE INVENTION

The subject matter disclosed herein relates to rotating shafts and, more particularly, to a system for shielding a rotating shaft environment from contaminants.

Some power plant systems, for example certain nuclear, simple cycle and combined cycle power plant systems, employ journal bearings along rotating shafts in their design and operation. These journal bearings are provided with a flow of lubricating oil which is contained from axial leakage by an oil deflector system. These oil deflector systems generally include oil deflector rings which are disposed in close proximity to the shaft and act as barriers to the lubricating oil. During operation, contaminants become deposited on the radial surface of these rings. These depositions produce friction with the shaft, rotor stator rubs, and coking, which lead to work stoppages and shorten the life of the shaft. Therefore, it is desirable to eliminate or limit the deposition of contaminants on the surface of the oil deflector rings. Some power plant systems limit contaminant deposition by blowing air between the outer oil deflector rings and the shaft, blowing contaminants off of and away from the lubricating oil and oil deflector rings. These systems fail to prevent contaminants from depositing on the outermost oil deflector rings which are still exposed to atmospheric air and the contaminants therein which are detrimental to the system.

### BRIEF DESCRIPTION OF THE INVENTION

Systems for shielding contaminants from a rotating shaft are disclosed. In one embodiment, a contaminant shield system for a shaft includes: a fluid seal disposed circumferentially about the shaft, the fluid seal substantially fluidly isolating an inner portion of the shaft from atmospheric air; an oil deflector ring disposed circumferentially about the inner portion of the shaft, the oil deflector ring having an inner surface facing a portion of the shaft exposed to a lubricating oil and an outer surface facing the fluid seal; and a fluid conduit interposed between the fluid seal and the outer surface of the oil deflector ring, the fluid conduit for receiving a fluid and releasing the fluid between the fluid seal and the outer surface of the oil deflector ring creating a positive pressure differential.

A first aspect of the disclosure provides a contaminant shield system for a shaft including: a fluid seal disposed circumferentially about the shaft, the fluid seal substantially fluidly isolating an inner portion of the shaft from atmospheric air; an oil deflector ring disposed circumferentially about the inner portion of the shaft, the oil deflector ring having an inner surface facing a portion of the shaft exposed to a lubricating oil and an outer surface facing the fluid seal; and a fluid conduit interposed between the fluid seal and the outer surface of the oil deflector ring, the fluid conduit for receiving a fluid and releasing the fluid between the fluid seal and the outer surface of the oil deflector ring creating a positive pressure differential.

A second aspect provides a power generation system including: a turbine, the turbine including a shaft; a generator operatively connected to the turbine; a fluid seal disposed circumferentially about the shaft, the fluid seal substantially fluidly isolating an inner portion of the shaft from atmospheric air; an oil deflector ring disposed circumferentially about the inner portion of the shaft, the oil deflector ring having an inner surface facing a portion of the shaft exposed to a lubricating oil and an outer surface facing the fluid seal; and a fluid conduit interposed between the fluid seal and the outer surface of the oil deflector ring, the fluid conduit for receiving a fluid and releasing the fluid between the fluid seal and the outer surface of the oil deflector ring creating a positive pressure differential.

A third aspect provides a combined cycle power generation system comprising: a gas turbine, the gas turbine including a shaft; a heat recovery steam generator (HRSG) operatively connected to the gas turbine; a steam turbine operatively connected to the HRSG, the steam turbine including a shaft; a generator operatively connected to at least one of the gas turbine or the steam turbine; a fluid seal disposed circumferentially about at least one of the gas turbine shaft or the steam turbine shaft, the fluid seal substantially fluidly isolating an inner portion of the shaft from atmospheric air; an oil deflector ring disposed circumferentially about the inner portion of the shaft, the oil deflector ring having an inner surface facing a portion of the shaft exposed to a lubricating oil and an outer surface facing the fluid seal; and a fluid conduit interposed between the fluid seal and the outer surface of the oil deflector ring, the fluid conduit for receiving a fluid and releasing the fluid between the fluid seal and the outer surface of the oil deflector ring creating a positive pressure differential.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a three-dimensional partial cut-away of an embodiment of a contaminant shield system in accordance with an aspect of the invention;

FIG. 2 shows an end-view, including a partial cut-away, of a portion of a contaminant shield system in accordance with an aspect of the invention;

FIG. 3 shows a three-dimensional partial cut-away of an embodiment of a contaminant shield system in accordance with an aspect of the invention;

FIG. 4 shows a three-dimensional partial cut-away schematic view of an embodiment of a contaminant shield system in accordance with an aspect of the invention;

FIG. 5 shows a three-dimensional partial cut-away schematic view of an embodiment of a contaminant shield system in accordance with an aspect of the invention;

FIG. 6 shows a partial cut-away schematic view of an embodiment of a contaminant shield system in accordance with an aspect of the invention;

FIG. 7 shows a partial cut-away schematic view of an embodiment of a contaminant shield system in accordance with an aspect of the invention;

FIG. 8 shows a partial cut-away schematic view of an embodiment of a contaminant shield system in accordance with an aspect of the invention;

FIG. 9 shows a partial cut-away schematic view of an embodiment of a contaminant shield system in accordance with an aspect of the invention;

FIG. 10 shows a schematic view of portions of a multi-shaft combined cycle power plant in accordance with an aspect of the invention;

FIG. 11 shows a schematic view of a single shaft combined cycle power plant in accordance with an aspect of the invention.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As indicated above, aspects of the invention provide for systems configured to shield a shaft and oil deflector system from contaminant deposition by using a fluid conduit to control a pressure differential between a fluid seal, which prevents leakage of fluids (i.e. steam) to the atmosphere using a low pressure vent, and an outer surface of an outermost oil ring deflector. The fluid conduit supplies a pressurized fluid to the cavity between the fluid seal and the outer surface of the outermost oil ring, thereby creating a positive pressure differential between the cavity and the atmosphere outside of the fluid seal and preventing contaminants and atmospheric air from entering the cavity.

In the art of power generation systems (including, e.g., nuclear reactors, steam turbines, gas turbines, etc.), rotating shafts with lubricated journal bearings are often employed as part of the system and may include an oil deflector system. Typically, the oil deflector system employs multiple sets of oil deflector rings to prevent against axial oil leakage and contaminants entering the journal bearings. The multiple sets of oil deflector rings are designed as a labyrinth seal, located circumferentially about the shaft with a working clearance between the shaft and oil deflector rings. However, the working clearance between the oil deflector rings and shaft enable some of the lubricating oil to leak out axially and for some contaminants to enter the system. This leakage of the lubricating oil and entrance of contaminants may result in contaminants building up on the oil deflector rings and entering the bearing system via the lubricating oil. This buildup and oil contamination can cause rotor-stator rubbing, poor bearing performance, coking and shortened system life. A higher average-contaminate level on the oil deflector rings and in the journal bearings detracts from the overall efficiency of the power generation system by causing large frictional, thermal and equipment maintenance losses.

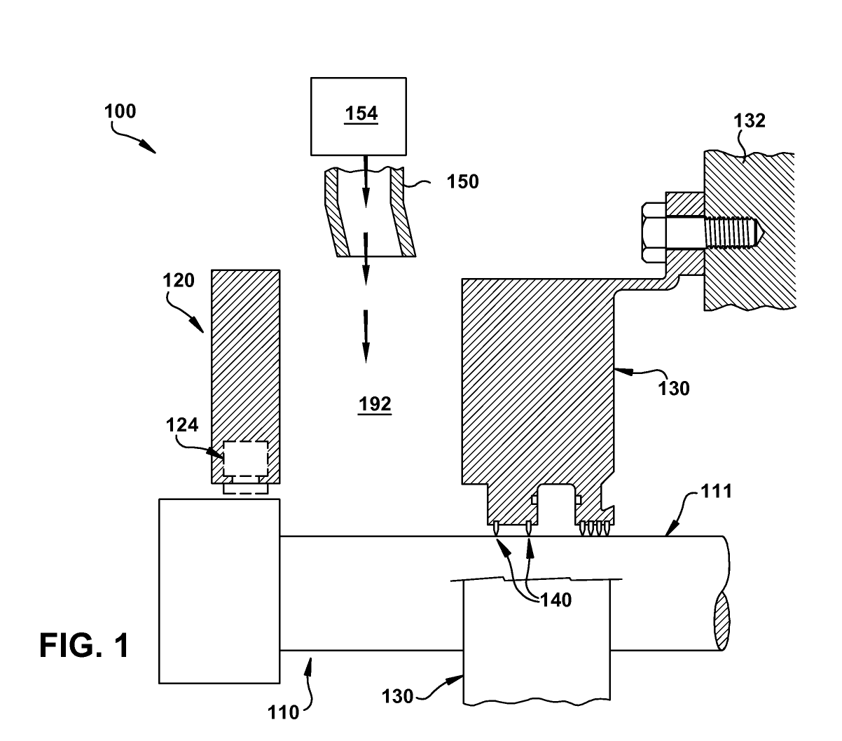

Turning to the figures, embodiments of a shaft and a contaminant shield system including a fluid conduit are shown, where the contaminant shield system may increase efficiency and life expectancy of the journal bearings, the shaft and the overall power generation system by reducing the amount of contaminants which come into contact with the lubricating oil and by reducing the deposition of contaminants upon the oil deflector rings. Each of the components in the figures may be connected via conventional means, e.g., via a common conduit or other known means as is indicated in FIGS. 1-11. Specifically, referring to FIG. 1, a three-dimensional partial cut-away of an embodiment of a contaminant shield system 100 is shown. Contaminant shield system 100 may include a shaft 110, a fluid seal 120, an oil deflector housing 130, at least one oil deflector ring 140 and a fluid conduit 150. Contaminant shield system 100 may receive a fluid from a fluid source 154 via fluid conduit 150, where fluid conduit 150 may be any conventional conduit for conveying fluid to contaminant shield system 100. Fluid conduit 150 may convey the fluid into a shield cavity 192 positioned between fluid seal 120 and oil deflector housing 130, thereby creating a positive pressure differential relative to atmospheric pressure on fluid seal 120. Delivery and manner of delivery of the fluid may be accomplished in any number of ways as discussed further below.

In an embodiment of the present invention, contaminant shield system 100 includes a plurality of oil deflector rings 140 which may be disposed circumferentially about shaft 110 to seal an inner portion 111 of shaft 110 from atmospheric exposure. It is understood that inner portion 111 may be in fluid communication with journal bearings as is common in the art. The plurality of oil deflector rings 140 may be conventional oil deflector rings known in the art. In one embodiment, oil deflector housing 130 of contaminant shield system 100 may be fluidly connected to a bearing housing 132. In one embodiment, contaminant shield system 100 may include a clearance shield 124 (shown in phantom) which may be at least partially interposed between fluid seal 120 and shaft 110. Clearance shield 124 may create a reduced working tolerance between shaft 110 and fluid seal 120, where the reduced working tolerance will minimize the entrance area for atmospheric air and increase the positive pressure differential. In one embodiment, fluid conduit 150 is comprised of a single conduit which may be oriented substantially circumferentially about shaft 110. In another embodiment, contaminant shield system 100 includes a plurality of fluid conduits 150 which may be disposed between fluid seal 120 and oil deflector housing 130. The plurality of fluid conduits 150 may be oriented substantially circumferentially about shaft 110 and may convey fluids to the contaminant shield system 100.

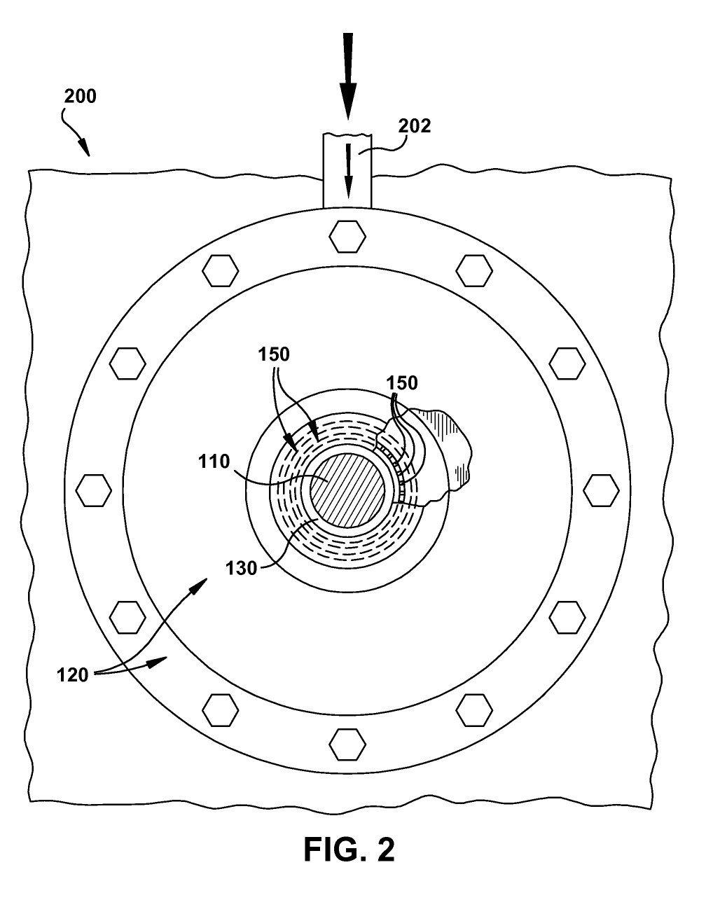

Turning to FIG. 2, a schematic partial cut-away of an end-view of a contaminant shield system 200 is shown according to embodiments. It is understood that elements similarly numbered between FIG. 1 and FIG. 2 may be substantially similar as described with reference to FIG. 1. Further, in embodiments shown and described with reference to FIGS. 2-11, like numbering may represent like elements. Redundant explanation of these elements has been omitted for clarity. Finally, it is understood that the components of FIGS. 1-11 and their accompanying descriptions may be applied to any embodiment described herein. Returning to FIG. 2, in this embodiment, contaminant shield system 200 may include a plurality of fluid conduits 150 which may be disposed circumferentially about shaft 110. In this embodiment, the plurality of fluid conduits 150 may convey fluid into the contaminant shield system 100 between fluid seal 120 and oil deflector housing 130. In one embodiment, plurality of fluid conduits 150 may receive the fluid from a common conduit 202.

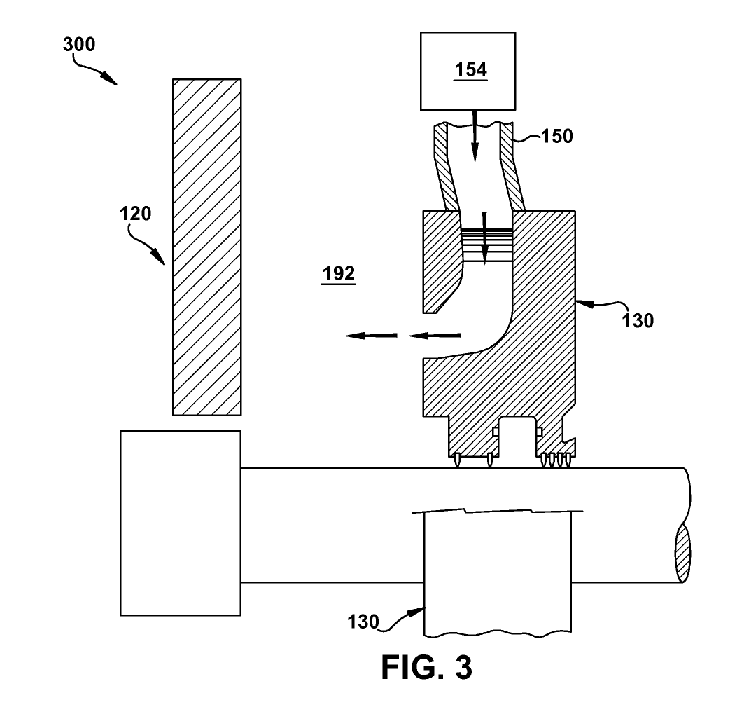

Turning to FIG. 3, a three-dimensional partial cut-away of an alternate embodiment of a contaminant shield system 300 is shown having at least one fluid conduit 150 located in fluid communication with oil deflector housing 130. In this embodiment, at least one fluid conduit 150 may be formed within oil deflector housing 130, with the at least one fluid conduit 150 being configured to receive a fluid from fluid source 154 and convey the fluid to shield cavity 192 between oil deflector housing 130 and the fluid seal 120, thereby creating a positive pressure differential in shield cavity 192.

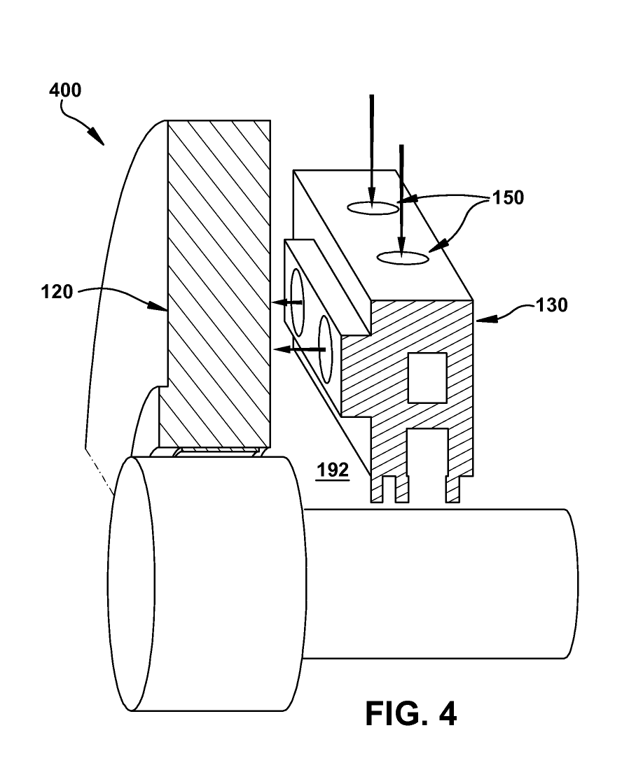

Turning to FIG. 4, a three-dimensional partial cut-away schematic view of an embodiment of a contaminant shield system 400 is shown according to embodiments of the invention having a plurality of fluid conduits 150 machined into oil deflector housing 130. The plurality of fluid conduits 150 may be configured to convey a fluid toward fluid seal 120 into shield cavity 192 creating a positive pressure differential. In one embodiment, the fluid being conveyed by the plurality of fluid conduits 150 may be filtered air.

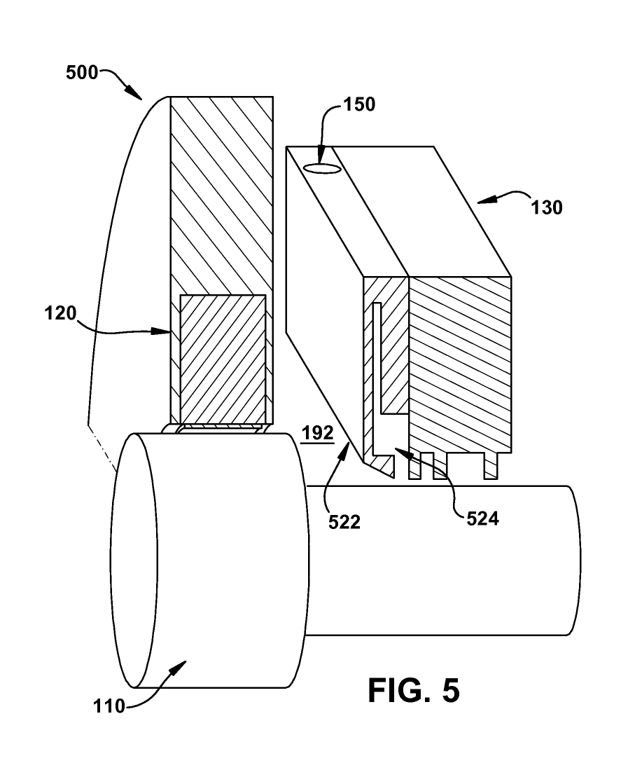

Turning to FIG. 5, a three-dimensional perspective view of a partial cross-sectional of contaminant shield system 500 according to embodiments of the invention is shown having at least one fluid conduit 150 fluidly connected to oil deflector housing 130. The at least one fluid conduit 150 may be configured to convey a fluid into shield cavity 192 between oil deflector housing 130 and fluid seal 120, creating a positive pressure differential. In one embodiment, at least one fluid conduit 150 may include a fluid seal shield 522 interposed between the at least one fluid conduit 150 and fluid seal 120. In one embodiment, fluid seal shield 522 may extend radially inwardly toward shaft 110 from at least one fluid conduit 150, creating an oil deflector cavity 524 defined by fluid seal shield 522, shaft 110 and oil deflector housing 130. The fluid conduit 150 may release a portion of the fluid into the oil deflector cavity 524 creating a positive pressure differential in oil deflector cavity 524. In one embodiment, fluid seal shield 522 may also extend axially, further defining oil deflector cavity 524.

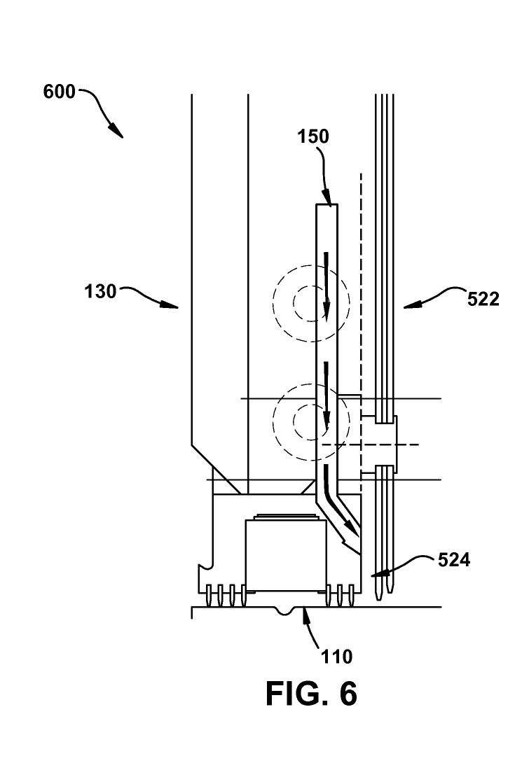

Turning to FIG. 6, a partial cut-away schematic view of an alternate embodiment of a contaminant shield system 600 is shown having a fluid seal shield 522 fluidly connected to oil deflector housing 130 which has a plurality of fluid conduits 150 machined into it. The plurality of fluid conduits 150 may be configured to convey a fluid away from oil deflector housing 130 into an oil deflector cavity 524 defined by shaft 110, oil deflector housing 130 and fluid seal shield 522, creating a positive pressure differential in oil deflector cavity 524.

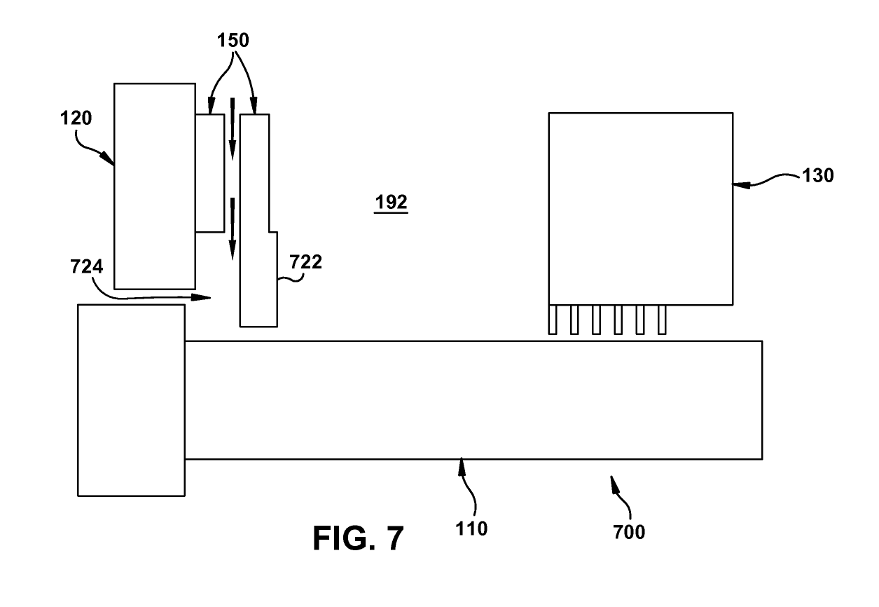

Turning to FIG. 7, a partial cut-away schematic view of an embodiment of contaminant shield system 700 is shown having at least one fluid conduit 150 fluidly connected to fluid seal 120. The at least one fluid conduit 150 may be configured to convey a fluid into shield cavity 192 between oil deflector housing 130 and fluid seal 120, creating a positive pressure differential. In one embodiment, contaminant shield system 100 may include a fluid seal shield 722 interposed between the at least one fluid conduit 150 and oil deflector housing 130. In one embodiment, fluid seal shield 722 may extend radially inwardly toward shaft 110 from at least one fluid conduit 150, creating a fluid seal cavity 724 defined by fluid seal 120, shaft 110 and fluid seal shield 722. The fluid conduit 150 may release a portion of the fluid into fluid seal cavity 724 creating a positive pressure differential in fluid seal cavity 724.

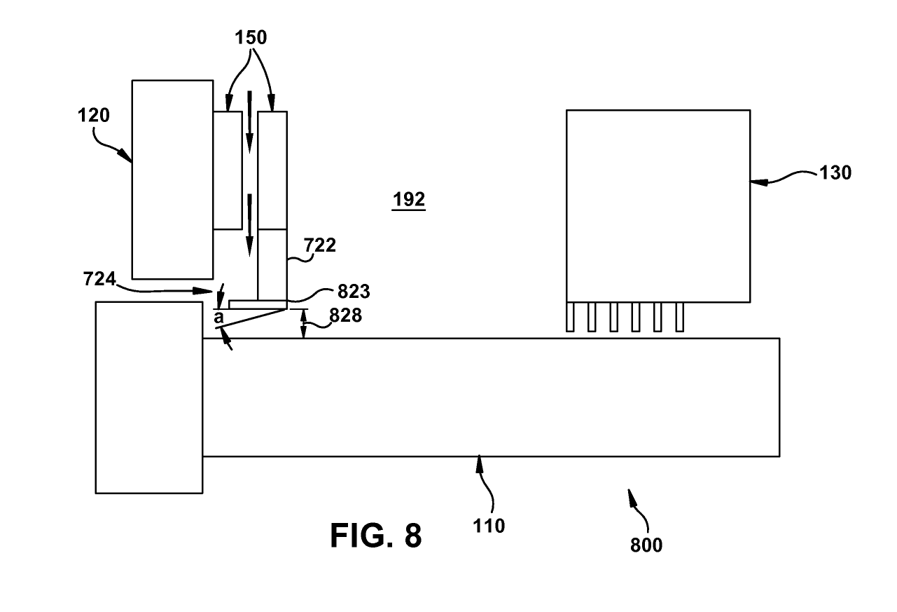

Turning to FIG. 8, a partial cut-away schematic view of an embodiment of a contaminant shield system 800 is shown having at least one fluid conduit 150 fluidly connected to the fluid seal 120. The contaminant shield system 100 includes a fluid seal shield 722 interposed between the at least one fluid conduit 150 and oil deflector housing 130. Fluid seal shield 722 may extend radially inwardly toward shaft 110 from at least one fluid conduit 150 and all or portions of fluid seal shield 722 may also extend axially, further defining fluid seal cavity 724. Fluid conduit 150 may release a portion of the fluid into fluid seal cavity 724 creating a positive pressure differential. In one embodiment of the present invention, an axially extended portion 823 of fluid seal shield 722 is positioned at an angle “a” relative to shaft 110 so as to decrease the size of opening 828 into shield cavity 192, where this decreased size of opening 828, among other things, increases the positive pressure differential. In another embodiment of the present invention, the angle “a” of axially extended portion 823 of fluid seal shield 722 relative to shaft 110 is adjustable across a range.

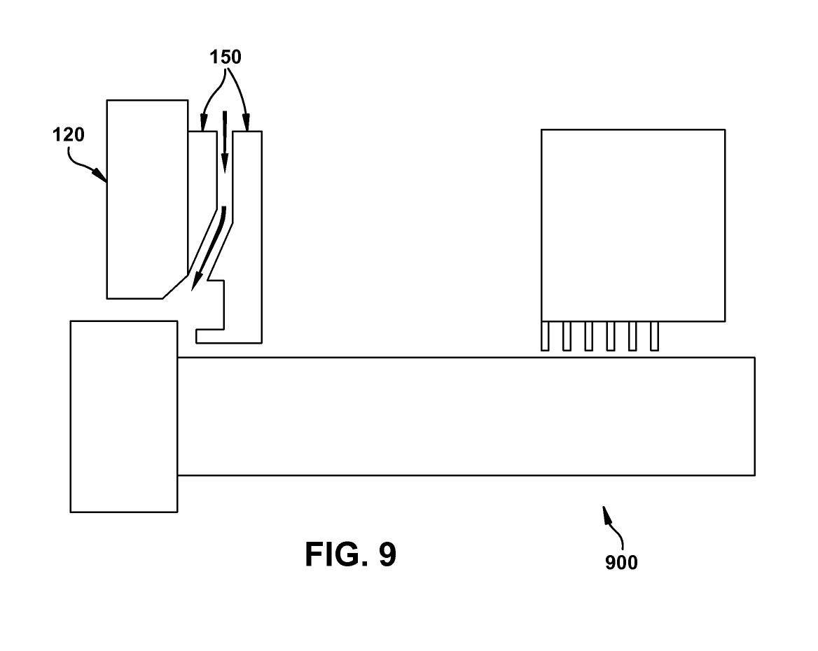

Turning to FIG. 9, a partial cut-away schematic view of an embodiment of a contaminant shield system 900 is shown having at least one fluid conduit 150 fluidly connected to fluid seal 120. The at least one fluid conduit 150 being configured at an angle toward fluid seal 120 such that fluid is directed toward fluid seal 120.

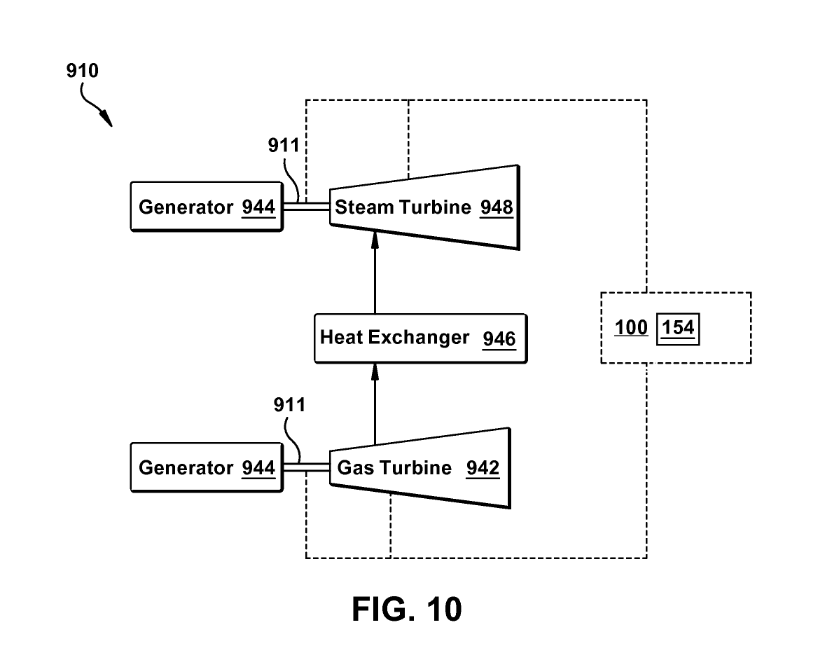

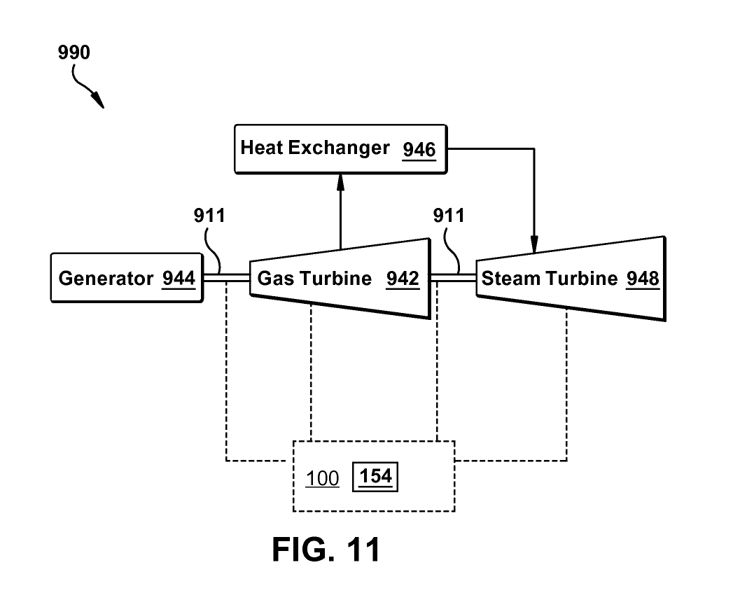

Turning to FIG. 10, a schematic view of portions of a multi-shaft combined cycle power plant 910 is shown. Combined cycle power plant 910 may include, for example, a gas turbine 942 operably connected to a generator 944. Generator 944 and gas turbine 942 may be mechanically coupled by a shaft 911, which may transfer energy between a drive shaft (not shown) of gas turbine 942 and generator 944. Shaft 911 may be fluidly connected to contaminant shield system 100 of FIG. 1 or other embodiments described herein. Also shown in FIG. 9 is a heat exchanger 946 operably connected to gas turbine 942 and a steam turbine 948. Heat exchanger 946 may be fluidly connected to both gas turbine 942 and a steam turbine 948 via conventional conduits (numbering omitted). Heat exchanger 946 may be a conventional heat recovery steam generator (HRSG), such as those used in conventional combined cycle power systems. As is known in the art of power generation, HRSG 946 may use hot exhaust from gas turbine 942, combined with a water supply, to create steam which is fed to steam turbine 948. Steam turbine 948 may optionally be coupled to a second generator system 944 (via a second shaft 911). It is understood that generators 944 and shafts 911 may be of any size or type known in the art and may differ depending upon their application or the system to which they are connected. Common numbering of the generators and shafts is for clarity and does not necessarily suggest these generators or shafts are identical. Generator system 944 and second shaft 911 may operate substantially similarly to generator system 944 and shaft 911 described above. In one embodiment of the present invention (shown in phantom), contaminant shield system 100 receives a fluid from a fluid source 154. Fluid source 154 may be fluidly connected to fluid conduit 150. Fluid source 154 may be a compressor, pressurized gas source or other fluid source as is known in the art. In another embodiment (shown in phantom), contaminant shield system 100 may receive a fluid via fluid conduit 150 in the form of compressed air generated from the operation of gas turbine 942. In another embodiment, steam turbine 946 may include at least one shaft 911 which is fluidly connected to contaminant shield system 100. In another embodiment gas turbine 942 may include at least one shaft 911 which is fluidly connected to contaminant shield system 100. In another embodiment, shown in FIG. 11, a single shaft combined cycle power plant 990 may include a single generator 944 coupled to both gas turbine 942 and steam turbine 946 via a single shaft 911. Shaft 911 may be fluidly connected to contaminant shield system 100 of FIG. 1 or other embodiments 200, 300, 400, 500, 600, 700, 800 or 900 described herein.

The contaminant shield system of the present disclosure is not limited to any one particular generator, power generation system or other system, and may be used with other power generation systems and/or systems (e.g., combined cycle, simple cycle, nuclear reactor, etc.). Additionally, the contaminant shield system of the present invention may be used with other systems not described herein that may benefit from the separation and protection of the contaminant shield system described herein.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A contaminant shield system for a shaft, the contaminant shield system comprising:
a fluid seal disposed circumferentially about the shaft, the fluid seal substantially fluidly isolating an inner portion of the shaft from atmospheric air;
an oil deflector ring disposed circumferentially about the inner portion of the shaft, the oil deflector ring having an inner surface facing a portion of the shaft exposed to a lubricating oil and an outer surface facing the fluid seal; and
a fluid conduit interposed between the fluid seal and the outer surface of the oil deflector ring, the fluid conduit for receiving a fluid and releasing the fluid between the fluid seal and the outer surface of the oil deflector ring creating a positive pressure differential there between with respect to the atmospheric air.

2. The contaminant shield system of claim 1, further comprising a plurality of oil deflector rings disposed circumferentially about the inner portion of the shaft.

3. The contaminant shield system of claim 2, further comprising a plurality of fluid conduits disposed circumferentially about the shaft interposed between the fluid seal and an outer surface of an outermost oil deflector ring.

4. The contaminant shield system of claim 3, wherein the plurality of fluid conduits are positioned within the outer surface of the outermost oil deflector ring.

5. The contaminant shield system of claim 3, wherein the plurality of fluid conduits are fluidly connected to an outer surface of the outermost oil deflector ring.

6. The contaminant shield system of claim 5, further comprising a fluid seal shield fluidly connected to the plurality of fluid conduits, the fluid seal shield being interposed between the plurality of fluid conduits and the inner surface of the fluid seal and extending radially inward creating a second positive pressure differential.

7. The contaminant shield system of claim 3, wherein the plurality of fluid conduits are fluidly connected to an inner surface of the fluid seal.

8. The contaminant shield system of claim 7, further comprising a fluid seal shield fluidly connected to the plurality of fluid conduits, the fluid seal shield being interposed between the plurality of fluid conduits and the outer surface of the outermost oil deflector ring and extending radially inward creating a second positive pressure differential.

9. The contaminant shield system of claim 8, wherein the fluid seal shield directs a portion of the released fluid toward the outer surface of the outermost oil deflector ring.

10. The contaminant shield system of claim 7, wherein the fluid is released by the fluid conduits at an angle away from the outer surface of the outermost oil deflector ring.

11. The contaminant shield system of claim 10, wherein the angle at which the fluid is released is adjustable across a range.

12. A power generation system comprising:
a turbine, the turbine including a shaft;
a generator operatively connected to the turbine;
a fluid seal disposed circumferentially about the shaft, the fluid seal substantially fluidly isolating an inner portion of the shaft from atmospheric air;
an oil deflector ring disposed circumferentially about the inner portion of the shaft, the oil deflector ring having an inner surface facing a portion of the shaft exposed to a lubricating oil and an outer surface facing the fluid seal; and
a fluid conduit interposed between the fluid seal and the outer surface of the oil deflector ring, the fluid conduit for receiving a fluid and releasing the fluid between the fluid seal and the outer surface of the oil deflector ring creating a positive pressure differential there between with respect to the atmospheric air.

13. The power generation system of claim 12, further comprising a plurality of oil deflector rings disposed circumferentially about the inner portion of the shaft.

14. The power generation system of claim 13, further comprising a plurality of fluid conduits disposed circumferentially about the shaft interposed between the fluid seal and an outer surface of an outermost oil deflector ring.

15. The power generation system of claim 14, wherein the plurality of fluid conduits are positioned within the outer surface of the outermost oil deflector ring.

16. The power generation system of claim 14, wherein the plurality of fluid conduits are fluidly connected to an inner surface of the fluid seal.

17. The power generation system of claim 16, further comprising a fluid seal shield fluidly connected to the plurality of fluid conduits, the fluid seal shield being interposed between the plurality of fluid conduits and the outer surface of the outermost oil deflector ring and extending radially inward creating a second positive pressure differential.

18. The power generation system of claim 17, wherein the fluid seal shield directs a portion of the released fluid toward the outer surface of the outermost oil deflector ring.

19. A combined cycle power generation system comprising:
a gas turbine, the gas turbine including a shaft;
a heat recovery steam generator (HRSG) operatively connected to the gas turbine;
a steam turbine operatively connected to the HRSG, the steam turbine including a shaft;
a generator operatively connected to at least one of the gas turbine or the steam turbine;
a fluid seal disposed circumferentially about at least one of the gas turbine shaft or the steam turbine shaft, the fluid seal substantially fluidly isolating an inner portion of the shaft from atmospheric air;
an oil deflector ring disposed circumferentially about the inner portion of the shaft, the oil deflector ring having an inner surface facing a portion of the shaft exposed to a lubricating oil and an outer surface facing the fluid seal; and
a fluid conduit interposed between the fluid seal and the outer surface of the oil deflector ring, the fluid conduit for receiving a fluid and releasing the fluid between the fluid seal and the outer surface of the oil deflector ring creating a positive pressure differential there between with respect to the atmospheric air.

20. The combined cycle power generation system of claim 19, wherein compressed air from the gas turbine supplies the fluid conduit.
